(19) United States
(12) Patent Application Publication
(10) Pub. No.: US 2018/0175443 A1
(43) Pub. Date: Jun. 21, 2018

(54) LITHIUM ION SECONDARY BATTERY

(71) Applicants: HYUNDAI MOTOR COMPANY, Seoul (KR); KIA MOTORS CORPORATION, Seoul (KR)

(72) Inventors: Seung Min Oh, Suwon-si (KR); Ki Seok Koh, Suwon-si (KR); Yeol Mae Yeo, Anseong-si (KR)

(73) Assignees: HYUNDAI MOTOR COMPANY, Seoul (KR); KIA MOTORS CORPORATION, Seoul (KR)

(21) Appl. No.: 15/720,721

(22) Filed: Sep. 29, 2017

(30) Foreign Application Priority Data
Dec. 19, 2016 (KR) 10-2016-0173617

(51) Int. Cl. H01M 10/0525; H01M 4/64; H01M 2/20; H01M 10/04

(52) U.S. Cl. CPC H01M 10/0525; H01M 4/64; H01M 2004/027; H01M 10/0459; H01M 2/202

(57) ABSTRACT

A lithium ion secondary battery includes an electrode assembly having a separator, a collector layer stacked on either side of the separator, and a positive electrode active material and a negative electrode active material formed on respective outer surfaces of the collector layer. The electrode assembly causes lithium ions to move to an inside of the separator by liquid electrolyte, which moves to the positive electrode active material and the negative electrode active material, thereby causing a charging/discharging reaction inside the collector layer.

### CROSS-REFERENCE TO RELATED APPLICATION

This application claims under 35 U.S.C. § 119(a) the benefit of priority to Korean Patent Application No. 10-2016-0173617 filed on Dec. 19, 2016, the entire contents of which are incorporated herein by reference.

### BACKGROUND

### (a) Technical Field

The present disclosure relates to a lithium ion secondary battery, and more particularly, to a lithium ion secondary battery which achieves enhanced performance.

### (b) Background Art

Generally, a secondary battery is rechargeable and capable of having a small size and a large capacity. With recent increase in the demand for portable electronic appliances, such as camcorders, portable computers, and cellular phones, research and development of secondary batteries that serve as power sources for such portable electronic appliances have been actively conducted. Representative examples of recently developed and used secondary batteries are nickel metal hydride (NiMH), lithium ion (Li-ion), and lithium ion polymer (Li-on polymer) batteries.

In these secondary batteries, a bare cell may have a can shape or a pouch shape depending on the shape of a case. Further, a can-shaped bare cell may be classified into a cylindrical type or a prismatic type.

In both types, a stack, in which a separator is interposed between two electrodes, or a winding body, on which the stack is wound, may form an electrode assembly. The electrode assembly may be contained, together with electrolyte, in a case.

In other words, a cell for a conventional lithium ion secondary battery has any one of various shapes, such as a cylindrical shape, a prismatic shape, or a pouch shape. Among these, a pouch-shaped cell is configured in such a manner that a positive electrode and a negative electrode, each having both coated surfaces and a separator, are alternately stacked one above another.

In such a pouch-shaped cell, the end surfaces of a positive electrode or a negative electrode are located at the outermost periphery of the cell and cannot participate in a reaction, although the end surfaces occupy the space inside the cell. This structure causes deterioration in the energy density of the battery.

Therefore, technologies for increasing the thickness of an electrode over a positive electrode or negative electrode collector have been developed in order to increase the energy density of the battery. In this case, the electrolyte has difficulty in permeating into the thick electrode, causing deterioration in the performance of the battery.

### SUMMARY OF THE DISCLOSURE

The disclosed embodiments attempt to solve the above-described problems associated with the related art. Thus, the present disclosure is directed to providing a lithium ion secondary battery, which may realize charging/discharging driving using only a single collector through a structure. In the structure, a positive electrode collector, a negative electrode collector, and a separator coexist. The structure allows the end surfaces of a positive electrode and a negative electrode, which are located at the outermost periphery of a laminated cell, to participate in a reaction. The structure further results in the enhanced performance of the battery.

In one aspect, the present disclosure provides a lithium ion secondary battery including an electrode assembly. The electrode assembly includes a separator, a collector layer stacked on either side of the separator, and a positive electrode active material and a negative electrode active material formed on respective outer surfaces of the collector layer. The electrode assembly causes lithium ions to move to an inside of the separator by liquid electrolyte, which moves to the positive electrode active material and the negative electrode active material, thereby causing a charging/discharging reaction inside the collector layer.

In an embodiment, the collector layer may have a plurality of micro pores. The micro pores form a movement passage for the lithium ions to move toward the inside of the separator.

In another embodiment, the micro pores may be arranged in a vertical direction and a horizontal direction of the collector layer and may be spaced apart from one another by a predetermined distance.

In still another embodiment, the separator may be configured as a polymer electrolyte or non-woven fabric separator.

In yet another embodiment, the separator may be formed of a solid electrolyte.

Other aspects and embodiments of the disclosure are discussed herein.

It is understood that the term “vehicle” or “vehicular” or other similar term as used herein is inclusive of motor vehicles in general. Such terms can encompass passenger automobiles including sports utility vehicles (SUV), buses, trucks, various commercial vehicles, watercraft including a variety of boats and ships, aircraft, and the like. Such terms can also encompass hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, such as for example both gasoline-powered and electric-powered vehicles.

The above and other features of the disclosure are also discussed herein.

### BRIEF DESCRIPTION OF THE DRAWINGS

The above and other features of the present disclosure are described in detail with reference to certain embodiments thereof illustrated the accompanying drawings, which are given hereinbelow by way of illustration only, and thus are not limitative of the present disclosure, and wherein:

FIG. 1 is a view illustrating a stacked structure for a lithium ion secondary battery according to an embodiment of the present disclosure;

FIG. 2 is a view illustrating a stacked structure for a conventional lithium ion secondary battery;

FIG. 3 is a view illustrating a collector layer for the lithium ion secondary battery according to an embodiment of the present disclosure; and

FIG. 4 is a view illustrating an electrode assembly for the lithium ion secondary battery according to an embodiment of the present disclosure.

It should be understood that the appended drawings are not necessarily to scale, presenting a somewhat simplified representation of various features illustrative of the basic principles of the disclosure. The specific design features of the embodiments disclosed herein, including, for example, specific dimensions, orientations, locations, and shapes will be determined in part by the particular intended application and use environment.

In the figures, like reference numbers refer to the same or equivalent parts of the present disclosure throughout the several figures of the drawing.

### DETAILED DESCRIPTION

Hereinafter, embodiments of the present disclosure will be described in detail with reference to the accompanying drawings to allow those skilled in the art to easily practice the present disclosure.

Advantages and features of the present disclosure and methods of achieving the same will be clearly understood with reference to the following detailed description of embodiments in conjunction with the accompanying drawings.

However, the present disclosure is not limited to the embodiments disclosed herein, but may be implemented in various different forms. The embodiments are merely given to make the present disclosure complete and to completely instruct the scope of the disclosure to those skilled in the art. The present disclosure should be defined by the scope of the claims.

In addition, in the description of the present disclosure, a detailed description of related known technologies and the like has been omitted where it is judged to make the subject of the present disclosure unclear.

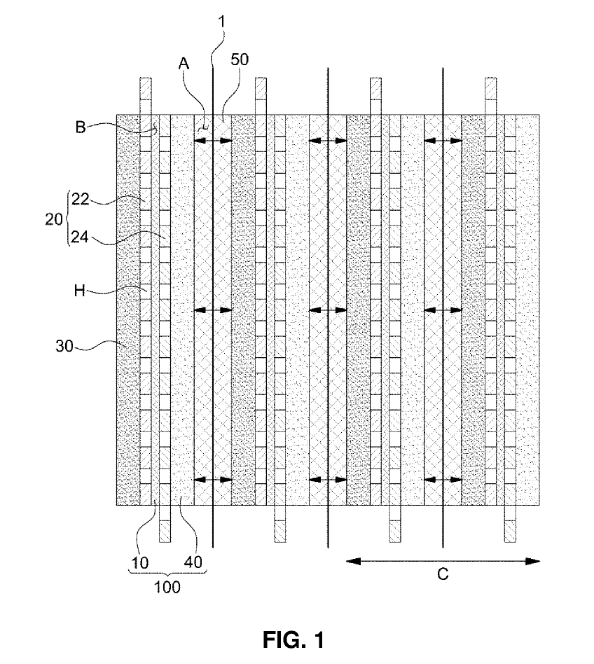

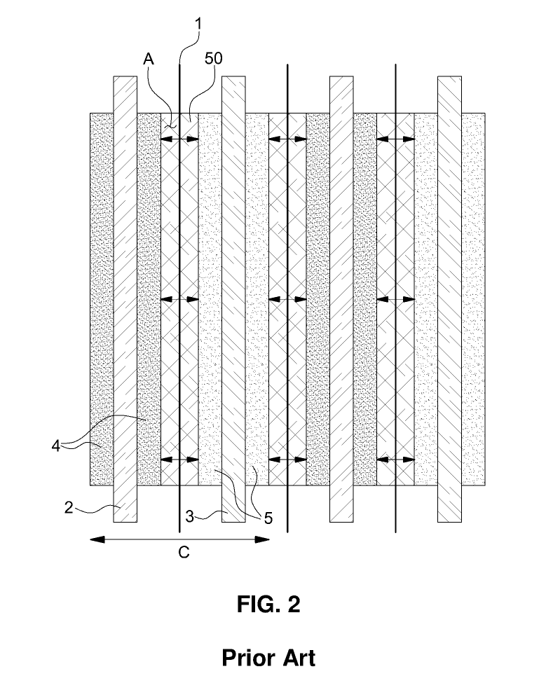

FIG. 1 is a view illustrating a stacked structure for a lithium ion secondary battery according to an embodiment of the present disclosure. FIG. 2 is a view illustrating a stacked structure for a conventional lithium ion secondary battery.

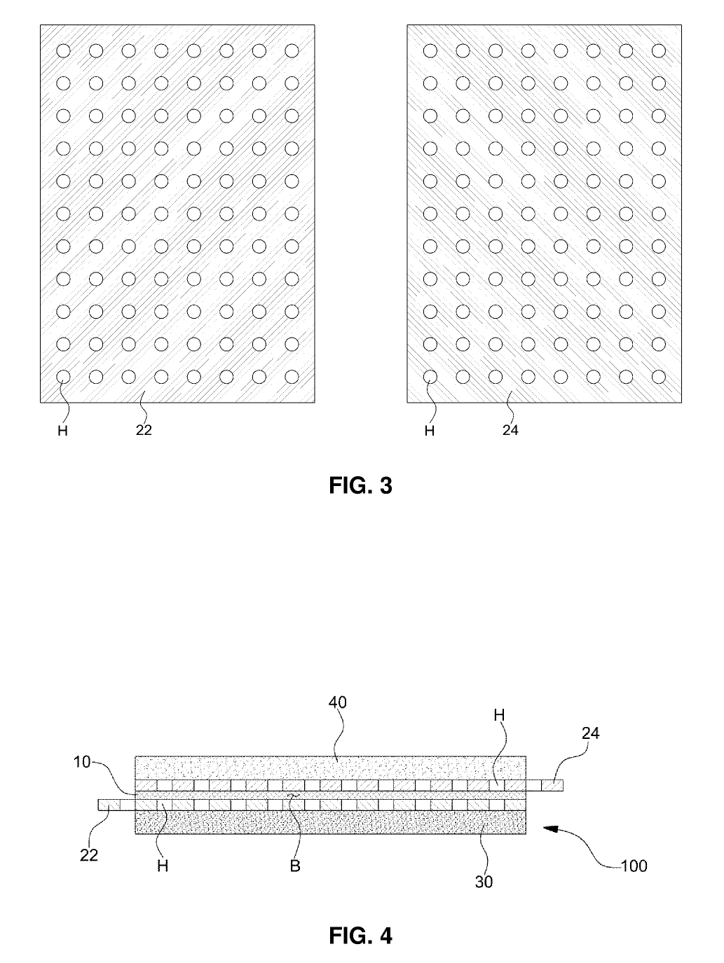

In addition, FIG. 3 is a view illustrating a collector layer for the lithium ion secondary battery according to an embodiment of the present disclosure. FIG. 4 is a view illustrating an electrode assembly for the lithium ion secondary battery according to an embodiment of the present disclosure.

First, the lithium ion secondary battery according to an embodiment includes an electrode assembly 100. The electrode assembly 100 includes a separator 10, a collector layer 20, a positive electrode active material 30, and a negative electrode active material 40.

Referring to FIG. 2, a conventional electrode assembly is illustrated as having a positive electrode collector 2 and a negative electrode collector 3. Both surfaces of each of the positive electrode collector 2 and the negative electrode collector 3 are coated, respectively, with a positive electrode active material 4 or a negative electrode active material 5. The positive electrode collector 2 and negative electrode collector 3 are stacked one above another in a plural number with a separator 1 interposed therebetween. Unlike the conventional electrode assembly of FIG. 2, the electrode assembly 100 of FIG. 1 includes three base materials, i.e. the separator 10, the collector layer 20 stacked on either side of the separator 10, and the positive electrode active material 30 and the negative electrode active material 40 formed on the outer surfaces of the collector layer 20. The three base materials constitute a single collector.

In other words, the conventional lithium ion secondary battery, as illustrated in FIG. 2, has an alternatingly stacked structure. In the structure, the positive electrode active material 4 is coated over both surfaces of the positive electrode collector 2, which is formed of aluminum. The negative electrode active material 5 is coated over both surfaces of the negative electrode collector 3, which is formed of copper having high standard reduction potential for preventing metal elution. The coated positive electrode collector 2, the separator 1, and the coated negative electrode collector 3 are alternately stacked one above another.

In the stacked structure described above, lithium ions move to the positive electrode active material 4 and the negative electrode active material 5, which are coated over both surfaces of the positive electrode collector 2 and the negative electrode collector 3, respectively, through coated liquid electrolyte 50. This causes a charging/discharging reaction in a first area A. Here, the positive electrode active material 4 and the negative electrode active material 5, which are coated over the outermost periphery of the positive electrode collector 2 and the negative electrode collector 3, respectively, cannot participate in a reaction due to the structural properties thereof.

Thus, the positive electrode active material 4 and the negative electrode active material 5, which are coated over the outermost periphery of the positive electrode collector 2 and the negative electrode collector 3, respectively, may cause deterioration in the energy density of the secondary battery. This is because the materials and electrodes exist in a stacked structure, although they do not participate in a charging/discharging reaction as described above.

The electrode assembly 100 according to the present embodiment, as illustrated in FIG. 1, is configured in such a manner that the separator 10 and a collector layer 20 are bonded to each other. The collector layer 20 includes a positive electrode collector 22 and a negative electrode collector 24 stacked on respective opposite sides of the separator 10. The positive electrode active material 30 and the negative electrode active material 40 are coated over the end surfaces of the positive electrode collector 22 and the negative electrode collector 24, respectively, so as to be driven. Thereby, unlike the prior art, the positive electrode active material 30 and the negative electrode active material 40, which are coated over the outermost periphery of the positive electrode collector and the negative electrode collector, respectively, may participate in a reaction. This structure may allow one electrode assembly 100 to operate as a single cell.

In other words, the electrode assembly 100 may allow the liquid electrolyte 50, which flows into the positive electrode active material 30 and the negative electrode active material 40, to form a movement passage of lithium ions. The electrode assembly 100 may allow lithium ions to move into the separator 10 along the movement passage, thereby causing a charging/discharging reaction inside the collector layer 20.

Here, the collector layer 20, which includes the positive electrode collector 22 and the negative electrode collector 24, has a plurality of micro pores H. The liquid electrolyte 50, which is coated over the first area A, passes through the collector layer 20 via the micro pores H to continue to the separator 10. The micro pores H form the movement passage for lithium ions.

Referring to FIG. 3, these micro pores H are arranged in the vertical direction and the horizontal direction of the collector layer 20. The micro pores H are spaced apart from one another by a predetermined distance in this embodiment.

Accordingly, in the present embodiment, the first area A over which the liquid electrolyte 50 is coated is the area in which charging and discharging have conventionally been performed. In addition, the inside of the collector layer 20, from which lithium ions move to the separator 10 through the micro pores H, is a second area B, which may participate in charging and discharging. The disclosed structure may allow one collector layer 20 to operate as a single cell. As a result, the energy density may be increased because the positive electrode active material and the negative electrode active material, which are coated over the outermost periphery of the positive electrode collector and the negative electrode collector, respectively, may participate in a reaction, unlike the prior art.

More specifically, in the electrode assembly 100, as illustrated in FIG. 4, three base materials, i.e. the separator 10, the collector layer 20 including the positive electrode collector 22 and the negative electrode collector 23, and the positive electrode active material 30 and the negative electrode active material 40 constitute a single collector. A charging/discharging reaction occurs in the second area B via the movement of lithium ions through the micro pores H, whereby driving the charging/discharging may be implemented using only a single collector.

The liquid electrolyte 50 is coated over the first area A. In the driving of the charging/discharging, because the liquid electrolyte 50 flows to the micro pores H through the positive electrode active material 30 or the negative electrode active material 40, thereby forming the movement passage of lithium ions toward the second area B, a charging/discharging reaction may occur in the second area B.

Here, the separator 10 is formed in the second area B. In the same manner as in the first area A, over which the liquid electrolyte 50 is coated, the separator 10, may be formed as a polymer electrolyte separator. More specifically, the separator 10 may be formed as a gel-type polymer electrolyte or non-woven fabric separator, which has several advantages, such as enhanced ion conductivity, good electrode bonding ability and mechanical properties, and ease of manufacture.

In addition, the separator 10 may take the form of a solid electrolyte in order to enhance the conductivity of lithium ions.

In other words, when a solid electrolyte is used instead of the liquid electrolyte as described above, safety may be considerably improved because no ignition or explosion occurs due to, for example, the decomposition reaction of liquid electrolyte. In addition, the energy density with regard to the mass and volume of the battery may be considerably enhanced because a negative electrode may be formed of a Li-metal or Li-alloy.

The solid electrolyte may be, for example, a glass-based acid sulfide (Li₃PO₄—Li₂S—SiS₂), a sulfide-halogen compound (LiI—Li₂S—P₂S₅), or a NASICON-type electrolyte (e.g. Na₃Zr₂Si₂PO₁₂, NaZr₂(PO₄)₃, or LiI+xTi₂-xAl(PO₄)₃). Ti or P ions may be replaced with Al, Ga, Sc, In, or Y. In addition, the solid electrolyte may be, for example, of a Thio-LISICON type (Li₄-xMI-yM′yS₄ [M=Si or Ge, and M′=P, Al, Zn, or Ga]), a Garnet type (Li₅La₃M₂O₁₂ [Ta, Nb], La may be replaced with Ba, Sr, or K), a Perovskite type (Li_{0.34}La_{0.51}TiO_{2.94}), or a LiPON type (gamma-Li₃PO₄).

In conclusion, as illustrated in FIG. 2, in the prior art, the positive electrode active material 4 and the negative electrode active material 5, which are coated over the outermost periphery of the positive electrode collector 2 and the negative electrode collector 30, respectively, cannot participate in a reaction. Thus, there is only a single energy generation area. In the present embodiment, as illustrated in FIG. 1, a charging/discharging reaction may occur inside the collector layer 20 so that three energy generation areas are realized in the same area as the prior art. This enables the realization of satisfactory battery performance when positive electrode and negative electrode coating layers are formed so as to be thick in order to increase the energy density.

As is apparent from the above description, through a structure in which a positive electrode collector, a negative electrode collector, and a separator coexist, driving of charging/discharging may be realized using only a single collector. The disclosed structure may allow the end surfaces of a positive electrode and a negative electrode, which are located at the outermost periphery of a laminated cell, to participate in a reaction, resulting in the enhanced performance of the battery.

Satisfactory battery performance may be accomplished thereby when positive electrode and negative electrode coating layers are formed so as to be thick in order to increase the energy density.

The disclosure has been described in detail with reference to embodiments thereof. However, it will be appreciated by those skilled in the art that changes may be made in these embodiments without departing from the principles and spirit of the disclosure, the scope of which is defined in the appended claims and their equivalents.

What is claimed is:

1. A lithium ion secondary battery comprising an electrode assembly including a separator, a collector layer stacked on either side of the separator, and a positive electrode active material and a negative electrode active material formed on respective outer surfaces of the collector layer,
wherein the electrode assembly causes lithium ions to move to an inside of the separator by liquid electrolyte, which moves to the positive electrode active material and the negative electrode active material, thereby causing a charging/discharging reaction inside the collector layer.

2. The battery of claim 1, wherein the collector layer has a plurality of micro pores to form a movement passage for the lithium ions to move toward the inside of the separator.

3. The battery of claim 2, wherein the micro pores are arranged in a vertical direction and a horizontal direction of the collector layer and are spaced apart from one another by a predetermined distance.

4. The battery of claim 1, wherein the separator is configured as a polymer electrolyte or non-woven fabric separator.

5. The battery of claim 1, wherein the separator is formed of a solid electrolyte.
